(19) United States
(12) Patent Application Publication
(10) Pub. No.: US 2024/0045841 A1
(43) Pub. Date: Feb. 8, 2024

(54) DYNAMIC OBJECT MODEL SYSTEM

(71) Applicant: Microsoft Technology Licensing, LLC, Redmond, WA (US)

(72) Inventors: Wenyuan WANG, Bellevue, WA (US); Yi SHEN, Sammamish, WA (US); Darren James FISHER, Sammamish, WA (US)

(21) Appl. No.: 18/319,620

(22) Filed: May 18, 2023

(30) Foreign Application Priority Data
Aug. 8, 2022 (LU) 502632

(51) Int. Cl. G06F 16/21; G06F 9/451

(52) U.S. Cl. CPC G06F 16/213; G06F 9/451

(57) ABSTRACT

A dynamic object model system identifies, from a first object data definition file, a first object definition of a first object of a first entity type; and identifies, from a second object data definition file, a second object definition of a second object of a second entity type. The first object definition defines an entity identifier for the first object, and the second object definition includes the entity identifier of the first object. The dynamic object model system determines, based on an object model definition, that objects of the second entity type refer to objects of the first entity type by entity identifier. Based on the object model definition, and based on the second object definition including the entity identifier of the first object, the dynamic object model system establishes a reference relationship between the first object and the second object within an object database.

### CROSS-REFERENCE TO RELATED APPLICATIONS

This application claims priority under 35 U.S.C. § 119 to Luxembourg Patent Application Number LU502632, filed Aug. 8, 2022, and entitled “DYNAMIC OBJECT MODEL SYSTEM,” the entire contents of which are incorporated by reference herein in their entirety.

### BACKGROUND

In computing, software applications define and operate on various data objects, with the structure of those data objects, and the nature of any relationships therebetween, being defined according to an object model. Classically, software applications have defined data objects using static object models. For example, when a software application is written using an object-oriented programming language (e.g., C++, C #, Java), that application inherently defines a static object model based on the entities (e.g., classes, structures) defined in the application's code. Once implemented in this manner, altering an application's object model involves changes to the application code, itself. This is error-prone and through coding errors can lead to application faults, such as crashes and data corruption, and other detrimental effects such as excessive resource usage. Additionally, altering an application's object model requires publishing new versions of the application, which can consume significant computing resources (e.g., network bandwidth, storage resources, processor cycles).

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In some aspects, the techniques described herein relate to a method, including: identifying, from a first object data definition file, a first object definition of a first object of a first entity type, the first object definition defining an entity identifier for the first object; identifying, from a second object data definition file that is different than the first object data definition file, a second object definition of a second object of a second entity type, the second object definition including the entity identifier of the first object; determining, based on an object model definition, that objects of the second entity type refer to objects of the first entity type by entity identifier; and based on the object model definition, and based on the second object definition including the entity identifier of the first object, establishing a reference relationship between the first object and the second object within an object database.

In some aspects, the techniques described herein relate to a computer system including: a processor; and a computer storage media that stores computer-executable instructions that are executable by the processor to cause the computer system to at least: identify, from a first object data definition file, a first object definition of a first object of a first entity type, the first object definition defining an entity identifier for the first object; identify, from a second object data definition file that is different than the first object data definition file, a second object definition of a second object of a second entity type, the second object definition including the entity identifier of the first object; determine, based on an object model definition, that objects of the second entity type refer to objects of the first entity type by entity identifier; and based on the object model definition, and based on the second object definition including the entity identifier of the first object, establish a reference relationship between the first object and the second object within an object database.

In some aspects, the techniques described herein relate to a computer storage media that stores computer-executable instructions that are executable by a processor to cause a computer system to at least: identify, from a first object data definition file, a first object definition of a first object of a first entity type, the first object definition defining an entity identifier for the first object; identify, from a second object data definition file that is different than the first object data definition file, a second object definition of a second object of a second entity type, the second object definition including the entity identifier of the first object; determine, based on an object model definition, that objects of the second entity type refer to objects of the first entity type by entity identifier; and based on the object model definition, and based on the second object definition including the entity identifier of the first object, establish a reference relationship between the first object and the second object within an object database.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the advantages and features of the systems and methods described herein can be obtained, a more particular description of the embodiments briefly described above will be rendered by reference to specific embodiments thereof which are illustrated in the appended drawings. Understanding that these drawings depict only typical embodiments of the systems and methods described herein, and are not therefore to be considered to be limiting of their scope, certain systems and methods will be described and explained with additional specificity and detail through the use of the accompanying drawings in which:

FIG. 1 illustrates an example computer architecture that facilitates use of dynamic object models;

FIG. 2 illustrates an example of a dynamic object model component;

FIG. 3 illustrates an example of cross-referencing entities that are defined in different files;

FIGS. 4A and 4B illustrate an example of an inline entity scenario;

FIGS. 5A and 5B illustrate an example of a nested cross-reference scenario;

FIG. 6 illustrates an example of defining a dynamically calculated field value;

FIG. 7 illustrates an example of defining an entity based on a template; and

FIG. 8 illustrates a flow chart of an example method for identifying objects using a dynamic object model system.

### DETAILED DESCRIPTION

At least some embodiments described herein provide a flexible and high customizable dynamic object model system. In embodiments, the dynamic object model system provides a runtime engine that enables developers to define an object model, and objects themselves, using a configuration that is separate application code that consumes the objects. This enables the object model to be dynamically updated separate from application code, such that the object model can change and evolve through changes to configuration, rather than changes to code. Updating an object model via configuration changes, rather than code changes, avoids coding errors and their negative effects (e.g., application faults such as crashes and data corruption, excessive resource usage, and the like). Additionally, it enables object model updates to be accomplished more quickly and efficiently, since these updates are accomplished via updates to configuration data, rather via updates to than to an entire application. Thus, for example, the amount of data that is involved in an object model update is reduced, which conserves storage resources for storing those updates, network bandwidth used to transport those updates, and processor cycles used to apply those updates.

In the embodiments described herein, this configuration is defined according to the JavaScript Object Notation (JSON), though the principles herein can be applied to a variety of markup languages (e.g., Extensible Markup Language (XML), YAML) or other language types. JSON is a file format and data interchange format that uses human-readable text to store and transmit data objects comprising attribute—value pairs and arrays. The structure and format of JSON files are defined by a JSON schema, which defines the structure of JSON data for validation, documentation, etc. The embodiments herein define ones or more JSON schema extension(s) that enables JSON to be suitable for use in a dynamic object model system. These JSON schema extension(s) use a variety of technical solutions to address a variety of technical problems.

One technical problem is that many schemas (including current JSON schemas) apply to single, stand-alone documents—such that all entities must be fully defined by that document. Stated differently, current JSON schemas lack fields that enable an entity defined in one JSON file to refer to an entity defined in another JSON file. One or more embodiments address this technical problem by defining an extended JSON schema that supports cross-referencing entities across multiple JSON files, through use of a field that references an entity that is defined in a separate JSON document. This enables the definition of entities to be spread across a plurality of JSON files, leading to individual JSON files that are smaller, simpler, and easier to parse, and the ability to organize data based on the file it is defined within. Using individual JSON files that are smaller and simpler can reduce memory consumption when loading/parsing those files, when compared to loading and parsing a larger and more complicated JSON file.

Another technical problem is that many schemas (including current JSON schemas) only permit static values to be assigned to fields. One or more embodiments address this technical problem by defining an extended JSON schema that enables the value a field to be defined within a schema using an expression (e.g., a lambda expression), and for that value to be automatically calculated upon creation of an entity using that expression. This eliminates the need for the field's data to be defined in an object definition, and leads to data consistency across objects.

Another technical problem is that many schemas (including current JSON schemas) lack templates or default values. One or more embodiments address this technical problem by defining an extended JSON schema that enables an entity to be defined based on a template, and for those templates to contain default values for fields (including using expressions). This can reduce the amount of data that needs to be defined in object definition files, since that data is defined once in a schema file, rather than multiple times in different definition files. By defining data once in template form, rather than multiple times in definition form, use of templates reduces the amount of storage needed to define a set of objects, and further leads to data consistency across those objects.

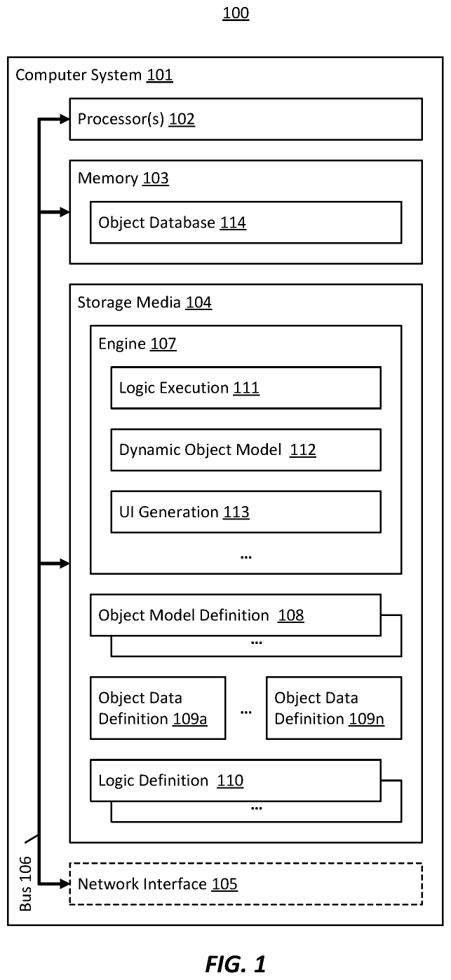

FIG. 1 illustrates an example computer architecture 100 that facilitates use of dynamic object models. As shown, computer architecture 100 includes a computer system 101 comprising processor(s) 102 (e.g., a single processor, or a plurality of processors), memory 103 (e.g., system or main memory), storage media 104 (e.g., a single computer-readable storage medium, or a plurality of computer-readable storage media), all interconnected by a bus 106. As shown, computer system 101 may also include a network interface 105 (e.g., one or more network interface cards) for interconnecting (via a network) to one or more other computer systems.

The storage media 104 is illustrated as storing computer-executable instructions implementing at least an engine 107. In embodiments, the engine 107 executes a software application that is defined according to a logic definition 110 (or a plurality of logic definitions, such as corresponding to different files), and an object model definition 108 (or a plurality of object model definition, such as corresponding to different files), based on a plurality of object data definitions 109 (e.g., object data definition 109a to object data definition 109n). In embodiments, the logic definition 110 comprises executable or interpretable code that is executed by a logic execution component 111 of the engine 107. In embodiments, the object model definition 108 defines an object model using a schema (e.g., a JSON schema), separately from the logic definition 110, and is consumed by a dynamic object model component 112. In embodiments, each of the plurality of object data definitions 109 is a different file (e.g., a JSON-formatted file) that defines object data that, based on operation of the dynamic object model component 112, results in creation of objects within an object database 114. In some embodiments, an application includes a user interface (UI), which is generated by a UI generation component 113.

In embodiments, by operating on a logic definition 110 and that is separated from an object model definition 108, the engine 107 provides an efficient dynamic object model system, in which the object model definition 108 can be updated separate from the logic definition 110. Thus, engine 107 reduces the frequency of the negative effects of coding errors (e.g., application faults such as crashes and data corruption, excessive resource usage, and the like). Additionally, engine 107 enables object model updates to be accomplished more quickly and efficiently than application updates, since these updates are accomplished via updates to configuration data, rather via updates to than to an entire application. Thus, engine 107 reduces the amount of data that is involved in an object model update, which conserves storage resources for storing those updates, network bandwidth used to transport those updates, and processor cycles used to apply those updates.

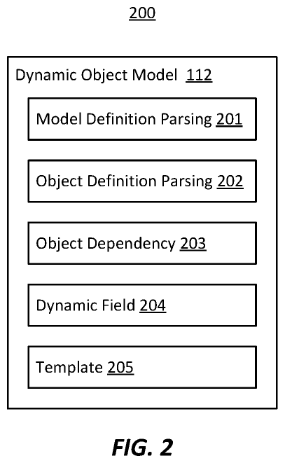

FIG. 2 illustrates an example 200 of internal components of the dynamic object model component 112 of FIG. 1. Each internal component of the dynamic object model component 112 depicted in FIG. 2 represents various functionalities that the dynamic object model component 112 might implement in accordance with various embodiments described herein. It will be appreciated, however, that the depicted components—including their identity and arrangement—are presented merely as an aid in describing example embodiments of the dynamic object model component 112.

In example 200, the dynamic object model component 112 includes a model definition parsing component 201, which parses an object model definition 108 to determine a schema (e.g., JSON schema) for objects defined in object data definitions 109, and which are operated on by the logic definition 110 (via the logic execution component 111). In embodiments, the dynamic object model component 112 operates at initiation of execution of an application by the engine 107 and/or repeatedly during execution of the application by the engine 107. Either way, the model definition parsing component 201 enables the object model used and understood by the logic definition 110 to be updated separately from the logic execution component 111.

In example 200, the dynamic object model component 112 also includes an object definition parsing component 202, which parses the object data definitions 109 to identify data for objects that are formatted according to the schema defined by the object model definition 108. In embodiments, based on execution of the object definition parsing component 202, the engine 107 creates corresponding in-memory objects within the object database 114.

As mentioned, one or more embodiments define a schema (e.g., an extended JSON schema) that supports cross-referencing entities across multiple files (e.g., multiple JSON files), through use of a field that references an entity that is defined in a separate file. To support this functionality, the dynamic object model component 112 includes an object dependency component 203, which identifies objects that are defined across different files (e.g., one object defined in object data definition 109a, and another object defined in data definition 109n), together with at least one dependency between those objects.

In an embodiment, the object model definition 108 enables the creation of parent-child relationships between objects, by at least integrating a parent identifier within a child object. In one example, the object model definition 108 defines a schema in which a parent entity can include one or more child entities, and in which child entities are defined as containing a property whose value includes their parent entity identifier. This enables the object dependency component 203 to search/query for all children belonging to a particular parent (even if the children were defined in separate file from the parent, and/or from each other), based on filtering children on a parent identifier. This also enables the object dependency component 203 to get the parent of given child, based on searching/querying for parents using a child's parent identifier.

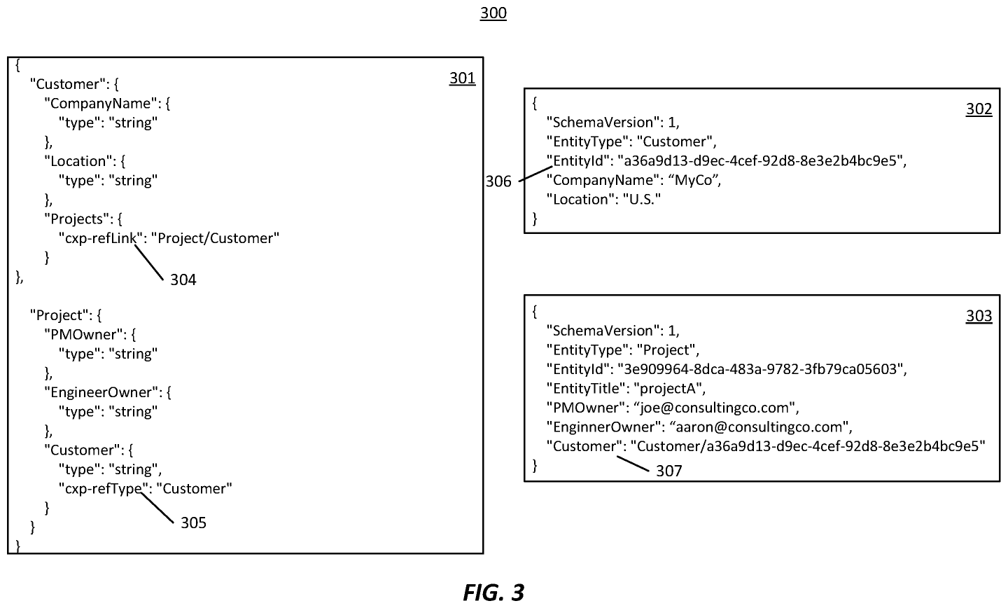

FIG. 3 illustrates an example 300 of cross-referencing entities that are defined in different files. In particular, example 300 includes a JSON schema 301 that defines a parent entity type, “Customer,” as including a field 304 (e.g., “cxp-refLink”) used to specify a parent-child relationship. In example 300, the value of field 304 is “Project/Customer,” which specifies a type of this entity's children (i.e., a “Project” entity type), and as well as a field type (i.e., “Customer”) used by child entities to refer a parent entity identifier. Thus, a Customer entity has, as children, a group of entities of type “Project,” and each Project entity uses a “Customer” field to indicate an identifier of its parent entity.

In example 300, the JSON schema 301 also defines a child entity type, “Project,” as including field 305 (e.g., “cxp-refType”) used to specify a type of its parent entity. In example 300, the value of field 305 is “Customer,” which is the parent entity type for Project entities. Not shown in JSON schema 301, in embodiments, each of the “Customer” entity type and the “Project” entity type inherit from a base entity, which includes fields such as EntityID, EntityType, EntityTitle, CreatedBy, CreatedOn, etc.

Example 300 also includes a JSON file 302 that includes an object definition for an entity of type “Customer” having an EntityID field 306 whose value is “a36a9d13-d9ec-4cef-92d8-8e3e2b4bc9e5,” and a JSON file 303 that includes an object definition for an entity of type “Project.” As shown, the object definition within JSON file 303 includes a field 307 of type “Customer” (e.g., in accordance with the schema definition of field 304), whose value (i.e., “a36a9d13-d9ec-4cef-92d8-8e3e2b4bc9e5”) references the EntityID field 306 for the parent Customer object. Based on JSON schema 301, and based on the object definitions of JSON file 302 and JSON file 303, the object dependency component 203 can identify a parent-child relationship between the Customer object having EntityID “a36a9d13-d9ec-4cef-92d8-8e3e2b4bc9e5” (JSON file 302) and the Project object having EntityID “3e909964-8dca-483a-9782-3fb79ca05603” (JSON file 303), and create this relationship within the object database 114.

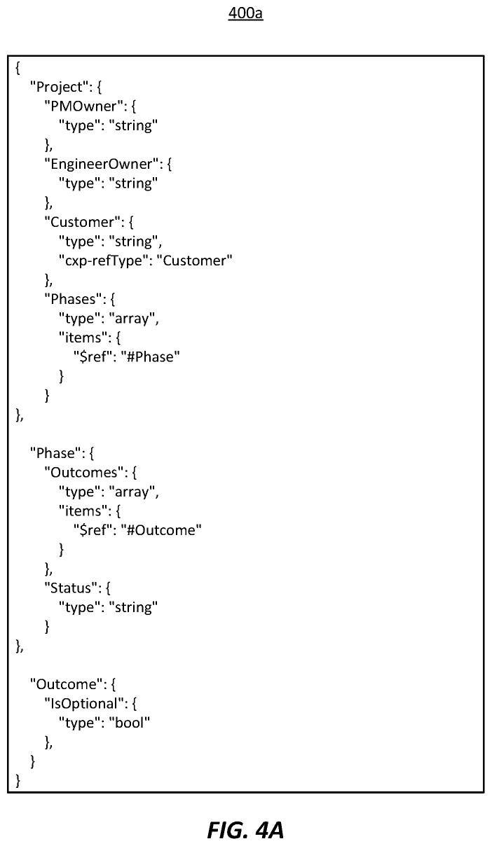

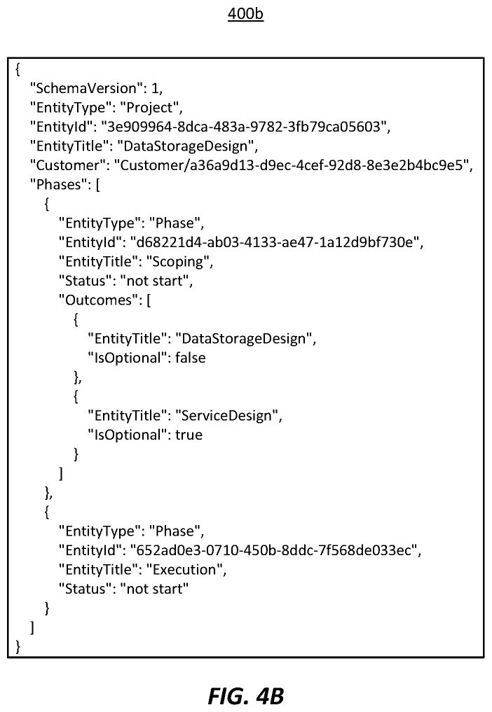

In embodiments, the cross-references described herein are compatible with conventional JSON references (e.g., “$ref”), in which a referenced entity is defined within the same file as a referencing entity. For example, FIGS. 4A and 4B illustrate an inline entity scenario, in which a locally-referenced entity is embedded in its parent entity, and those entities are all stored in the same JSON document. FIG. 4A illustrates an example 400a of a schema that extends the schema definition of the “Project” entity of example 300 to also include an array of referenced “Phase” entities (which, in turn, include references to Outcomes). FIG. 4B illustrates an example 400b of a JSON file that includes an object definition for an entity of type Project that references the Customer object having EntityID “a36a9d13-d9ec-4cef-92d8-8e3e2b4bc9e5” (as in example 300), and in which the Customer object can be defined in a separate JSON file than the one shown in example 400b. However, in example 400b, the JSON file also defines phases that are part of that Project according to the schema of example 400a.

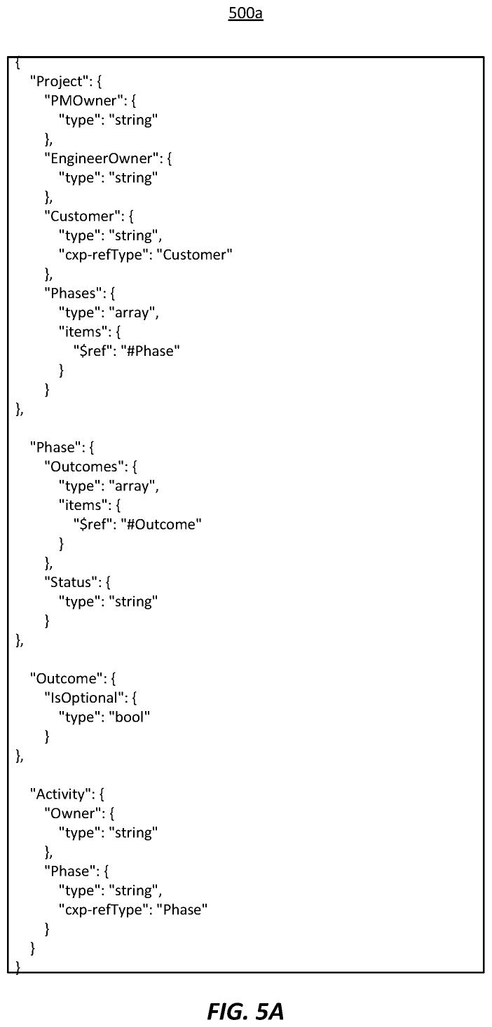

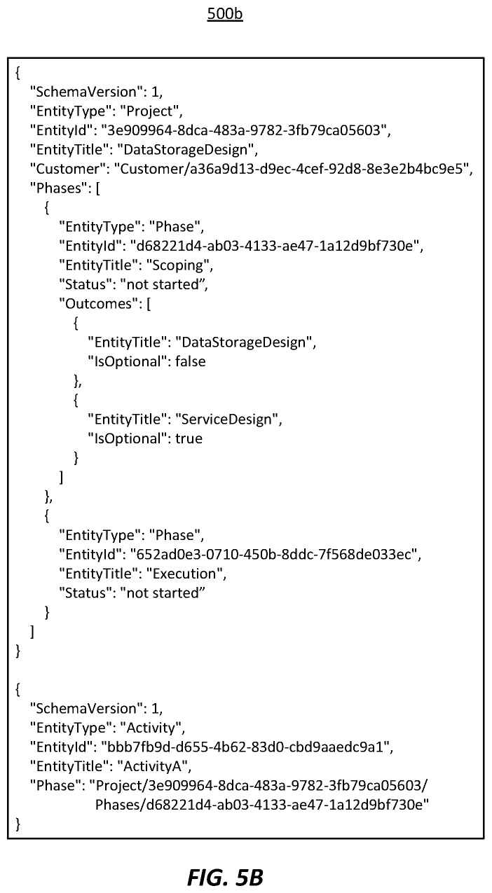

In embodiments, the object model definition 108 enables references to be used to create multiple levels of nesting (to any number of levels). For example, FIGS. 5A and 5B illustrate a nested cross-reference scenario. FIG. 5A illustrates an example 500a of a schema that extends the schema of example 400a to also include an “Activity” entity that includes a reference to a Phase entity type. FIG. 5B illustrates an example 500b of a JSON file that includes an object definition for an entity of type Project that references the Customer object having EntityID “a36a9d13-d9ec-4cef-92d8-8e3e2b4bc9e5” (as in example 400b). However, in example 500b, the JSON file also defines an Activity that references both a Project (i.e., EntityID “3e909964-8dca-483a-9782-3fb79ca05603”) and a Phase (i.e., EntityID “d68221d4-ab03-4133-ae47-1a12d9bf730e”). Thus, in example 500b, a Customer object (EntityID “a36a9d13-d9ec-4cef-92d8-8e3e2b4bc9e5”) has a child Project object (EntityID “3e909964-8dca-483a-9782-3fb79ca05603”), and the Project object includes a Phase object (EntityID “d68221d4-ab03-4133-ae47-1a12d9bf730e”) that in turn has a child Activity object (EntityID “bbb7fb9d-d655-4b62-83d0-cbd9aaedc9a1”). Notably, each of the Customer object, the Project object, and the Activity object can be defined in separate JSON files.

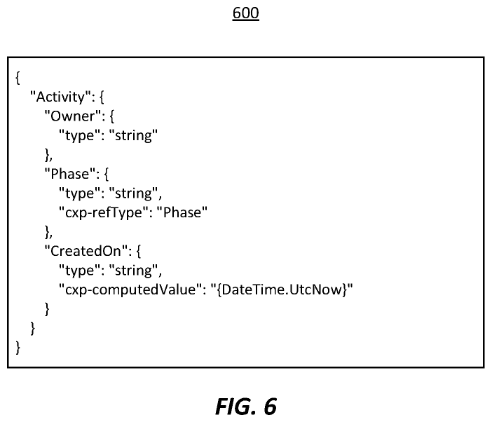

In example 200, the dynamic object model component 112 also includes a dynamic field component 204 that computes a field's value based on an expression specified in a schema definition (e.g., object model definition 108). In embodiments, for a given entity, the object model definition 108 defines a field's value based on an expression (e.g., programmatic and/or mathematical). Then, when an object of that entity type is created from one of object data definitions 109 and/or is updated/edited, the dynamic field component 204 computes that field's value based on this expression. In some embodiments, expressions comprise lambda expressions, though a variety of expression types could be used. FIG. 6 illustrates an example 600 of defining a dynamically calculated field value, in which an “Activity” entity type includes a “CreatedOn” field, whose value is dynamically computed based on the lambda expression “{DateTime.UtcNow}.”

Some embodiments support expressions using multiple languages; for example, a default lambda language may be EcmaScript/Javascript, but if the computed value starts with an “@” symbol, the lambda is defined using a second language, such as C #. In some embodiments, an expression may define its result in terms of other fields of the entity; for example, for a “Person” entity having a “FirstName” and a “LastName” field, the value of an “Initials” field could be defined by a lambda expression that returns a concatenation of the first character of the FirstName field and the first character of the LastName field.

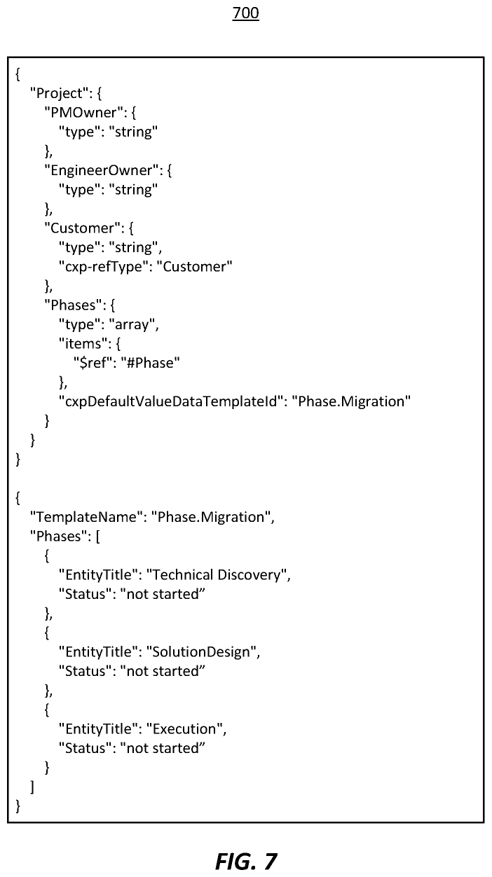

In example 200, the dynamic object model component 112 also includes a template component 205 that enables a schema to define a template for an entity, including defining a default value for a field. In existing JSON schemas, a default value can only be a simple type, such as a string. In embodiments, the template component 205 provides the ability to define a complex type as a default value, allowing multiple entries to be generated in a default value. FIG. 7 illustrates an example 700 of defining an entity based on a template. In example 700, a schema defines a template named “Phase.Migration,” which includes an array of default phases (including default values for those phases, such as the illustrated default titles and statuses). Additionally, in example 700, a “Project” entity defines its phases based on this template (i.e., ‘“cxpDefaultValueDataTemplatelD”:“Phase.Migration”’). In embodiments, operation of the dynamic field component 204 and the template component 205 can be combined. For example, the default value within a template can be defined using an expression, such as a lambda expression.

In some embodiments, an object model definition 108 defines a field that references one of multiple types. For example, the “cxp-refType” field used in the examples herein may indicate an array of strings, such as “[“US_Customer”, “EU_Customer” ],” allowing the string prefix in the data to indicate both type of entity referenced (e.g., Customer), and a foreign key/primary key of that type (e.g., US, EU).

Returning to FIG. 1, the engine 107 includes a UI generation component 113. In some embodiments, the UI generation component 113 generates a UI based on a data model defined by the object model definition 108. For example, if the object model definition 108 defines a field to contain text (e.g., a string type), in embodiments the UI generation component 113 automatically selects a text box UI element, a label UI element, or the like to display the field's data. In another example, if the object model definition 108 defines a field to contain a Boolean, in embodiments the UI generation component 113 automatically selects a radio button UI element, a switch UI element, or the like to display the field's data. In another example, if the object model definition 108 defines a field to contain an enum or an array of strings, in embodiments the UI generation component 113 automatically selects a dropdown list UI element, a listbox UI element, or the like to display the field's data. In embodiments, this enables a UI developer to focus on UI layout, rather than particular UI element types.

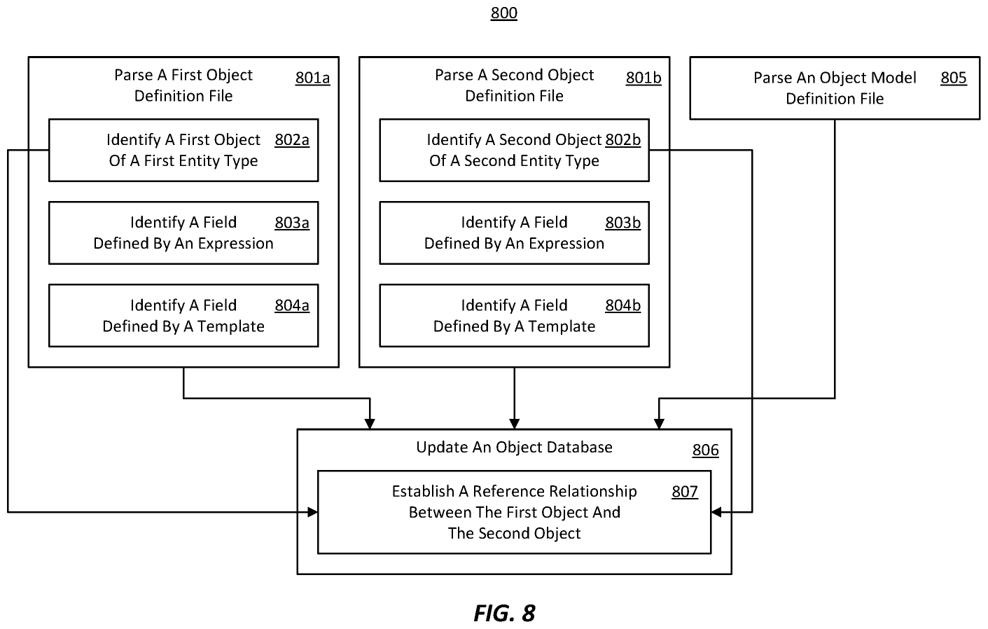

The components of the dynamic object model component 112 are now described in connection with FIG. 8, which illustrates a flow chart of an example method 800 for identifying objects using a dynamic object model system. In embodiments, instructions for implementing method 800 are encoded as computer-executable instructions (e.g., engine 107) stored on a computer storage media (e.g., storage media 104) that are executable by a processor (e.g., processor 102) to cause a computer system (e.g., computer system 101) to perform method 800.

The following discussion now refers to a number of methods and method acts. Although the method acts may be discussed in certain orders, or may be illustrated in a flow chart as occurring in a particular order, no particular ordering is required unless specifically stated, or required because an act is dependent on another act being completed prior to the act being performed.

Referring to FIG. 8, in embodiments, method 800 comprises an act 801a of parsing a first object definition file, and an act 801b of parsing a second object definition file (referred to collectively as an act 802 of parsing object definition files). As shown, there is no ordering required between act 801a and act 801b, and thus in various embodiments these acts are performed serially (in either order) or in parallel. For example, the object definition parsing component 202 parses object data definition 109a (e.g., JSON file 302) and data definition 109n (e.g., JSON file 303). In embodiments, each object definition file defines at least one object based on a schema (e.g., using a markup language). In some embodiments, the object definition files are JSON files, such that the first object data definition file and the second object data definition file are each JSON files. However, the principles described herein can be applied to other markup languages (e.g., XML, YAML).

In FIG. 8, in some embodiments act 801a includes an act 802a of identifying a first object of a first entity type, and in some embodiments act 801b includes an act 802b of identifying a second object of a second entity type (referred to collectively as an act 803 of identifying different objects from the object definition files). In some embodiments, act 802a comprises identifying, from a first object data definition file, a first object definition of a first object of a first entity type, the first object definition defining an entity identifier for the first object. In an example, the object definition parsing component 202 identifies a “Customer” object from JSON file 302, having an EntityID field 306 comprising a value of “a36a9d13-d9ec-4cef-92d8-8e3e2b4bc9e5.” In some embodiments, act 802b comprises identifying, from a second object data definition file that is different than the first object data definition file, a second object definition of a second object of a second entity type, the second object definition including the entity identifier of the first object. In an example, the object definition parsing component 202 identifies a “Project” object from JSON file 303, having a field 307 comprising a value that includes EntityID “a36a9d13-d9ec-4cef-92d8-8e3e2b4bc9e5.”

In some embodiments, act 801a and act 801b also include an act 803 of identifying a field defined by an expression (i.e., an act 803a within act 801a, and an act 803b within act 801b). For example, referring to FIG. 6, when identifying an object definition of an “Activity” object, the dynamic field component 204 determines, based on a schema (e.g., parsed in act 805, discussed infra), that a “CreatedOn” field of that object has a value that is be dynamically calculated based on an expression. In FIG. 6, this expression is the lambda expression “{DateTime.UtcNow}.” Thus, in some embodiments, method 800 comprises identifying, from the object model definition, an entity type comprising a field whose value is defined by an expression; and based on creating or updating an object having the entity type, using the expression to dynamically calculate a value for the field. In some embodiments, the expression is a lambda expression, though the language used for the expression can vary. Notably, operation of act 803 eliminates the need for a field's data to be defined in an object definition, and leads to data consistency across objects.

In FIG. 8, in some embodiments act 801a and act 801b also include an act 804 of identifying a field defined by a template (i.e., an act 804a within act 801a, and an act 804b within act 801b). For example, referring to FIG. 7, when identifying an object definition of an “Project” object, the template component 205 determines, based on a schema (e.g., parsed in act 805, discussed infra), that the object includes phases (e.g., Technical Discovery, SolutionDesign, and Execution) that are defined by a template. Thus, in some embodiments, method 800 comprises identifying, from the object model definition, an entity type comprising a field defined by a template; and based on creating an object having the entity type, using the template to populate a default value for the field. In embodiments, this default value is defined by an expression, such as a lambda expression.

Notably, act 801a and act 801 can include any combination of one or more of act 802, act 803, or act 804. Thus, for example, in some embodiments, method 800 only operates to establish relationships between objects (e.g., based on act 802), only operates to use dynamic fields (e.g., based on act 803), or only operates to use templates (e.g., based on act 804). In other embodiments, method 800 operates to perform a combination of these functions.

Method 800 comprises an act 805 of parsing an object model definition file. As shown, there is no ordering required between act 805 and act 801, and thus in various embodiments these acts are performed serially (in either order) or in parallel. In an example, the model definition parsing component 201 parses object model definition 108 (e.g., JSON schema 301) to identify a schema for the object data definitions 109 (e.g., JSON file 302 and JSON file 303) parsed in act 801.

In some embodiments, the object model definition 108 defines relationships between different entity types; for example, in example 300 the JSON schema 301 defines a Customer entity to have Project entities as children. Thus, in some embodiments, act 805 comprises determining, based on an object model definition, that objects of the second entity type refer to objects of the first entity type by entity identifier. In an embodiment, the object model definition includes a first schema definition of the first entity type (e.g., the Customer entity in JSON schema 301), the first schema definition including a first reference field (e.g., field 304) defining an identity of the second entity type (e.g., Project) as a child entity type, and a particular field (e.g., Customer) used by objects of the second entity type to refer to an object of the first entity type as a parent. In an embodiment, the object model definition includes a second schema definition of the second entity type (e.g., the Project entity in JSON schema 301), second schema definition including a second reference field (e.g., field 305) defining the particular field (e.g., Customer).

Method 800 comprises an act 806 of updating an object database. In an example, based on the objects identified in act 801, the dynamic object model component 112 updates object database 114 to include these objects.

As shown by arrows in FIG. 8, in some embodiments (e.g., when method includes act 802), act 806 includes an act 807 of establishing a reference relationship between the first object and the second object. In some embodiments, act 807 comprises, based on the object model definition, and based on the second object definition including the entity identifier of the first object, establishing a reference relationship between the first object and the second object within an object database. In an example, the object dependency component 203 establishes a reference relationship between the Customer object defined in JSON file 302 and the Project object defined in JSON file 303. For example, in embodiments, establishing the reference relationship between the first object and the second object within the object database comprises establishing the first object as a parent of the second object within the object database. In some embodiments, establishing the reference relationship between the first object and the second object includes, based on the first schema definition (e.g., the Customer entity in JSON schema 301), determining that the first object has a child object of the second entity type (e.g., the Project entity defined in JSON schema 301); searching for an object of the second entity type that includes the particular field (e.g., Customer), a value of which comprises the entity identifier for the first object; and based on the searching, identifying the second object.

Notably, by using a schema that supports cross-referencing entities across multiple files, through use of a field that references an entity that is defined in a separate document, method 800 enables the definition of entities to be spread across a plurality of JSON files, leading to simpler and easier to understand individual JSON files and the ability to organize data based on the file it is defined within.

Although not illustrated in FIG. 8, in some embodiments the engine 107 uses the schema and objects identified by method 800 to present a UI. In particular, in some embodiments, the UI generation component 113 generates a UI based on a data model defined by the object model definition 108. Thus, in some embodiments, method 800 further comprises determining a UI element type for presenting a field based on the object model definition. In embodiments, determining the UI element type includes at least one of: determining a text box UI element type or a label UI element type based on the object model definition defining the field to contain text; determining a radio button UI element type or a switch UI element type based on the object model definition defining the field to contain a Boolean value; or determining a dropdown list UI element type or a listbox UI element type based on the object model definition defining the field to contain an enum or an array. In embodiments, generating a UI based on a data model, including using the data model to automatically select UI element types, enables a UI developer to focus on UI layout, rather than particular UI element types.

Embodiments of the disclosure may comprise or utilize a special-purpose or general-purpose computer system (e.g., computer system 101) that includes computer hardware, such as, for example, one or more processors (e.g., processor 102) and system memory (e.g., memory 103), as discussed in greater detail below. Embodiments within the scope of the present disclosure also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media (e.g., storage media 104). Computer-readable media that carry computer-executable instructions and/or data structures are transmission media. Thus, by way of example, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), solid state drives (SSDs), flash memory, phase-change memory (PCM), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., network interface 105), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

It will be appreciated that the disclosed systems and methods may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. Embodiments of the disclosure may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

It will also be appreciated that the embodiments of the disclosure may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). A cloud computing model can be composed of various characteristics, such as on-demand self-service, broad network access, resource pooling, rapid elasticity, measured service, and so forth. A cloud computing model may also come in the form of various service models such as, for example, Software as a Service (SaaS), Platform as a Service (PaaS), and Infrastructure as a Service (IaaS). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present disclosure may be embodied in other specific forms without departing from its essential characteristics. Such embodiments may include a data processing device comprising means for carrying out one or more of the methods described herein; a computer program comprising instructions which, when the program is executed by a computer, cause the computer to carry out one or more of the methods described herein; and/or a computer-readable medium comprising instructions which, when executed by a computer, cause the computer to carry out one or more of the methods described herein. The described embodiments are to be considered in all respects only as illustrative and not restrictive. All changes which come within the meaning and range of equivalency of the claims are to be embraced within their scope.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

What is claimed:

1. A method comprising:
identifying, from a first object data definition file, a first object definition of a first object of a first entity type, the first object definition defining an entity identifier for the first object;
identifying, from a second object data definition file that is different than the first object data definition file, a second object definition of a second object of a second entity type, the second object definition including the entity identifier of the first object;
determining, based on an object model definition, that objects of the second entity type refer to objects of the first entity type by entity identifier; and
based on the object model definition, and based on the second object definition including the entity identifier of the first object, establishing a reference relationship between the first object and the second object within an object database.

2. The method of claim 1, wherein the first object data definition file and the second object data definition file are each JavaScript Object Notation files.

3. The method of claim 1, wherein establishing the reference relationship between the first object and the second object within the object database comprises establishing the first object as a parent of the second object within the object database.

4. The method of claim 1, wherein the object model definition includes:
a first schema definition of the first entity type, the first schema definition including a first reference field, defining:
an identity of the second entity type as a child entity type, and
a particular field used by objects of the second entity type to refer to an object of the first entity type as a parent; and
a second schema definition of the second entity type, second schema definition including a second reference field defining the particular field.

5. The method of claim 4, wherein establishing the reference relationship between the first object and the second object includes:
based on the first schema definition, determining that the first object has a child object of the second entity type;
searching for an object of the second entity type that includes the particular field, a value of which comprises the entity identifier for the first object; and
based on the searching, identifying the second object.

6. The method of claim 1, further comprising:
identifying, from the object model definition, an entity type comprising a field whose value is defined by an expression; and
based on creating or updating an object having the entity type, using the expression to dynamically calculate a value for the field.

7. The method of claim 6, wherein the expression is a lambda expression.

8. The method of claim 1, further comprising:
identifying, from the object model definition, an entity type comprising a field defined by a template; and
based on creating an object having the entity type, using the template to populate a default value for the field.

9. The method of claim 8, wherein the default value is defined by an expression.

10. The method of claim 1, further comprising determining a UI element type for presenting a field based on the object model definition.

11. The method of claim 10, wherein determining the UI element type includes at least one of:
determining a text box UI element type or a label UI element type based on the object model definition defining the field to contain text;
determining a radio button UI element type or a switch UI element type based on the object model definition defining the field to contain a Boolean value; or
determining a dropdown list UI element type or a listbox UI element type based on the object model definition defining the field to contain an enum or an array.

12. A computer system comprising:
a processor; and
a computer storage media that stores computer-executable instructions that are executable by the processor to cause the computer system to at least:
identify, from a first object data definition file, a first object definition of a first object of a first entity type, the first object definition defining an entity identifier for the first object;
identify, from a second object data definition file that is different than the first object data definition file, a second object definition of a second object of a second entity type, the second object definition including the entity identifier of the first object;
determine, based on an object model definition, that objects of the second entity type refer to objects of the first entity type by entity identifier; and
based on the object model definition, and based on the second object definition including the entity identifier of the first object, establish a reference relationship between the first object and the second object within an object database.

13. The computer system of claim 12, the computer-executable instructions also executable by the processor to cause the computer system to:
identify, from the object model definition, an entity type comprising a field whose value is defined by an expression; and
based on creating or updating an object having the entity type, use the expression to dynamically calculate a value for the field.

14. The computer system of claim 12, the computer-executable instructions also executable by the processor to cause the computer system to:
identify, from the object model definition, an entity type comprising a field defined by a template; and
based on creating an object having the entity type, use the template to populate a default value for the field.

15. The computer system of claim 12, the computer-executable instructions also executable by the processor to cause the computer system to:
determine a UI element type for presenting a field based on the object model definition.

16. The computer system of claim 12, wherein establishing the reference relationship between the first object and the second object within the object database comprises establishing the first object as a parent of the second object within the object database.

17. The computer system of claim 12, wherein the object model definition includes:
a first schema definition of the first entity type, the first schema definition including a first reference field, defining:
an identity of the second entity type as a child entity type, and
a particular field used by objects of the second entity type to refer to an object of the first entity type as a parent; and
a second schema definition of the second entity type, second schema definition including a second reference field defining the particular field.

18. The computer system of claim 17, wherein establishing the reference relationship between the first object and the second object includes:
based on the first schema definition, determining that the first object has a child object of the second entity type;
searching for an object of the second entity type that includes the particular field, a value of which comprises the entity identifier for the first object; and
based on the searching, identifying the second object.

19. The computer system of claim 12, the computer-executable instructions also executable by the processor to cause the computer system to determine a UI element type for presenting a field based on the object model definition, including at least one of:
determining a text box UI element type or a label UI element type based on the object model definition defining the field to contain text;
determining a radio button UI element type or a switch UI element type based on the object model definition defining the field to contain a Boolean value; or
determining a dropdown list UI element type or a listbox UI element type based on the object model definition defining the field to contain an enum or an array.

20. A computer program product comprising a hardware storage device that stores computer-executable instructions that are executable by a processor to cause a computer system to at least:
identify, from a first object data definition file, a first object definition of a first object of a first entity type, the first object definition defining an entity identifier for the first object;
identify, from a second object data definition file that is different than the first object data definition file, a second object definition of a second object of a second entity type, the second object definition including the entity identifier of the first object;
determine, based on an object model definition, that objects of the second entity type refer to objects of the first entity type by entity identifier; and
based on the object model definition, and based on the second object definition including the entity identifier of the first object, establish a reference relationship between the first object and the second object within an object database.
